(19) United States
(12) Patent Application Publication
(10) Pub. No.: US 2006/0198687 A1
(43) Pub. Date: Sep. 7, 2006

(54) Pencil

(75) Inventor: Yoshifumi Uchibori, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Three Sisters, Inc.

(21) Appl. No.: 11/340,475

(22) Filed: Jan. 27, 2006

(30) Foreign Application Priority Data
Mar. 2, 2005 (JP) 2005-057186

(51) Int. Cl. B43K 19/00

(52) U.S. Cl. 401/49

(57) ABSTRACT

With conventional pencils, there is the problem that it takes time to fill out the answer sheet. Furthermore, there is the problem that the pencil lead is wasted when going over the same spots on the answer sheet multiple times. With a pencil wherein the shape of a surface of a tip portion of a pencil lead is a substantially rectangular shape, it is possible to fill out the marking spots on the answer sheet quickly. Moreover, it is preferable that the length of the longer sides of the substantially rectangular shape is at least about 2 mm and at most about 5 mm. Moreover, it is preferable that the length of the shorter sides of the substantially rectangular shape is at least about 0.3 mm and at most about 0.8 mm. Furthermore, it is preferable that the tip portion of the pencil lead includes an obliquely cut-off portion.

### BACKGROUND OF THE INVENTION

1. Field of the Invention

The present invention relates to pencils and the like used to fill out answer sheets.

2. Description of Related Art

In conventional pencils, as shown in FIG. 6, the pencil lead has a cylindrical shape and the tip portion of the pencil lead is sharpened to a conical shape. Moreover, pencils used for answer sheets that can produce dark and well-defined marks are commercially available (see website <URL:http://www.bungu-ya.net/pen/pen2.html> on the Internet).

However, there is the problem that it takes time to fill out an answer sheet with conventional pencils. Another problem with conventional pencils is that, when filling out the answer sheet, the pencil lead is wasted when going over the same spots on the answer sheet multiple times.

### SUMMARY OF THE INVENTION

In a pencil according to a first aspect of the present invention, the shape of a surface of a tip portion of a pencil lead is a substantially rectangular shape.

With such a configuration, it is possible to fill out marking spots on an answer sheet quickly.

Moreover, in a pencil according to a second aspect of the present invention, the width of the surface of the tip portion of the pencil lead is at least about 2 mm and at most about 5 mm. That is to say, the length of the longer sides of the substantially rectangular shape is at least about 2 mm and at most about 5 mm.

With such a configuration, the pencil matches the marking spots on the answer sheet, so that the marking spots can be filled out quickly.

Furthermore, in a pencil according to a third aspect of the present invention, the shorter width of the surface shape of the tip portion of the pencil lead is at least about 0.3 mm and at most about 0.8 mm. That is to say, the length of the shorter sides of the substantially rectangular shape is at least about 0.3 mm and at most about 0.8 mm.

With such a pencil, the pencil lead tends not to break and is not wasted.

Moreover, in a pencil according to a fourth aspect of the present invention, the longitudinal width of the tip portion of the pencil lead is approximately the diameter of the pencil lead. That is to say, the length of the longer sides of the substantially rectangular shape is approximately the diameter of the pencil lead.

With such a configuration, the total width of the pencil lead can be used when filling out a marking spot and the pencil lead is used efficiently.

Moreover, a pencil according to a fifth aspect of the present invention is characterized in that, in addition to the features of the first aspect, the surface area of the tip portion of the pencil lead is smaller than the cross-sectional area of the pencil lead. Here, “cross-sectional area of the pencil lead” means the maximum cross-sectional area of the pencil lead that is obtained when cutting the pencil lead in a plane that is perpendicular to the longitudinal length of the pencil lead.

In such a configuration, the pencil lead tends not to break when filling out a marking spot.

Furthermore, a pencil according to a sixth aspect of the present invention is characterized in that, in addition to the features of the first to fifth aspects, the tip portion of the pencil lead is cut off obliquely. That is to say, in a pencil of according to a sixth aspect, the tip portion of the pencil lead comprises an obliquely cut-off portion, in addition to the features of the first to fifth aspects.

With such a configuration, a user who normally holds the pencil obliquely can very easily fill out a marking spot. Moreover, since the marking width can be large, it becomes easy to fill out marking spots with one stroke.

Moreover, a pencil according to a seventh aspect of the present invention is characterized in that, in addition to the features of the sixth aspect, the obliquely cut-off portion defines an angle of 3 to 30° with respect to a plane intersecting orthogonally with the longitudinal direction of the pencil lead.

With such a configuration, a user who holds the pencil obliquely can more easily fill out marking spots. Moreover, since the marking width can be large, it becomes easier to fill out marking spots with one stroke.

Furthermore, in a pencil according to an eighth aspect of the present invention, in addition to the features of the first to seventh aspects, the pencil lead has a hardness of 2B or 3B.

With such a configuration, marks that can be read by an optical reading device can be placed quickly in the marking spots.

With a pencil according to the present invention, marking spots on an answer sheet can be filled out quickly.

### BRIEF DESCRIPTION OF THE DRAWINGS

FIG. 1 is an overall view of a pencil according to an embodiment of the present invention.

FIGS. 2A-2C show the surface shape of the tip portion of a pencil lead.

FIGS. 3A-3D are iagrams showing the pencil from four different sides.

FIG. 4 is a diagram showing the shape of the tip portion of the pencil.

FIGS. 5A-5F are diagrams illustrating a method for manufacturing the pencil.

FIG. 6 is an overall view of a conventional pencil.

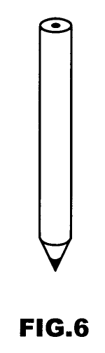

### DETAILED DESCRIPTION OF THE INVENTION

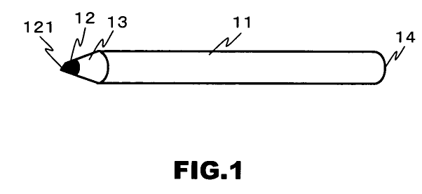

FIG. 1 shows an overall view of a pencil according to an embodiment of the present invention. This pencil includes a grasping portion 11 that is held by hand and a pencil lead 12.

The grasping portion 11 is preferably made of wood. However, there is no limitation to the material of the grasping portion 11. The grasping portion 11 preferably has a thickness that is comfortable to hold. Specifically, the grasping portion 11 preferably has a diameter of, for example, 8 mm to 10 mm. Moreover, the shape of the grasping portion 11 may be cylindrical, hexagonally columnar, or a different shape. Furthermore, it is preferable that a tip portion 13 of the grasping portion 11 has a shape that gradually tapers off toward a tip portion 121 of the pencil lead 12 (see FIG. 1). Thus, the pencil lead 12 tends not to break and it is possible to mark the marking spots while observing them, so that the user can accurately mark the intended spots. Here, “marking spot” means a space on an answer sheet that is marked. A marking spot is thus a space on the answer sheet where an answer mark is placed.

Moreover, the cross-section of the pencil lead 12 may be circular, rectangular or quadratic, for example. If the cross-section of the pencil lead 12 is circular, then it is preferable that its diameter is about 2 mm to 5 mm. If the cross-section of the pencil lead 12 is rectangular or quadratic, then it is preferable that the length of the longer side is about 2 mm to 5 mm. This way, the surface of the tip portion 121 (described below) that is in contact with the paper, becomes approximately the same as the width of the marks on the answer sheet.

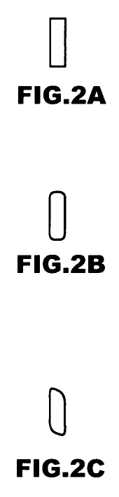

Furthermore, it is preferable that the shape of the surface of the tip portion 121 of the pencil lead 12 is substantially rectangular. FIGS. 2A through 2C show examples of the surface shape of the tip portion 121 of the pencil lead 12. The surface shape of the tip portion 121 of the pencil lead 12 may be basically rectangular, or it may have the shape of a rectangle with rounded corners (see FIG. 2B), or it may substantially have the shape of a parallelogram (see FIG. 2C). Even when the surface shape of the tip portion 121 of the pencil lead 12 is a parallelogram, then this still corresponds to the above-noted substantially rectangular shape.

It should be noted that it is preferable that a pencil is preferable wherein the length of the longer sides of the surface shape of the tip portion 121 of the pencil lead 12 is at least about 2 mm and at most about 5 mm. It is even more preferable that the length of the longer sides of the surface shape of the tip portion 121 of the pencil lead 12 is about 2.5 mm. That is because this is a width with which the marks on the answer sheet can be set with one stroke. Moreover, the length in the longitudinal direction of the tip portion 121 of the pencil lead 12 may be approximately the diameter of the pencil lead.

Moreover, a pencil is preferable wherein the length of the shorter sides of the surface shape of the tip portion 121 of the pencil lead 12 is at least about 0.3 mm and at most about 0.8 mm. Moreover, a pencil is preferable wherein the length of the shorter sides of the surface shape of the tip portion 121 of the pencil lead 12 is about 0.5 mm. This way, the tip of the pencil lead 12 of the pencil tends not to break, and the surface that is in contact with the paper is small, so that the resistance is low and the marking spots can be filled in with high speed. Moreover, wastage of the pencil lead can be avoided, because the surface area that needs to be marked twice is small.

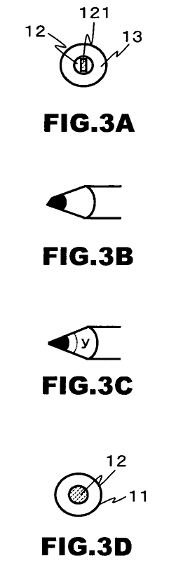

FIG. 3A shows a top view of a pencil according to Embodiment 1 of the present invention. FIG. 3B shows a front view of the pencil according to Embodiment 1 of the present invention. The front view is the view taken from the side in which the width of the tip 121 of the pencil lead 12 is larger. FIG. 3C is a lateral view of the pencil according to Embodiment 1. This lateral view is the view taken from the side in which the width of the tip 121 of the pencil lead 12 is smaller. FIG. 3D is a bottom view of the pencil according to Embodiment 1, and is the view taken from the rear end 14 of the pencil. In FIGS. 3A through 3D, the cross-sectional shape of the pencil lead 12 may be circular, rectangular, quadratic or elliptic, for example.

As can be seen from FIG. 3A, the surface area of the tip portion 121 of the pencil lead 12 is smaller than the cross-sectional area of the pencil lead 12. Thus, the pencil lead 12 does not tend to break, even when during an examination the answer sheet is filled out forcefully, which is preferable. It is preferable that the angle (y) in FIG. 3C is 22° to 27°. This way, the user can easily mark the marking spots while watching them, and the pencil lead does not tend to break.

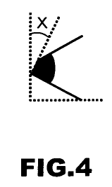

FIG. 4 shows that the tip portion 121 of the pencil lead 12 has an obliquely cut-off portion. It is preferable that the angle (x) of the obliquely cut-off portion with respect to the plane of the paper that is filled out with that pencil is an angle of 3° to 30°. That is because when people hold a pencil, they do not hold it vertically with respect to the paper plane but at an angle of 3° to 30°. As shown in FIG. 4, the tip portion 121 of the pencil lead 12 is cut obliquely.

It is preferable that the degree of hardness of the pencil lead of the pencil is 2B or 3B. If a large force is used when attempting to fill out the marking spot of the answer sheet with one stroke, the pencil lead 12 tends to break. Also it is very tiring to mark the answers to, for example, several hundred questions by using a lot of force during the tense situation of an exam. Accordingly, the user usually does not mark using sufficient force. On the other hand, when the mark is thin, it may be difficult to read with an optical reading device for answer sheets. Accordingly, trial and error has shown that it is preferable that a pencil a described in FIGS. 1 to 3 has a pencil lead with a hardness degree of 2B or 3B.

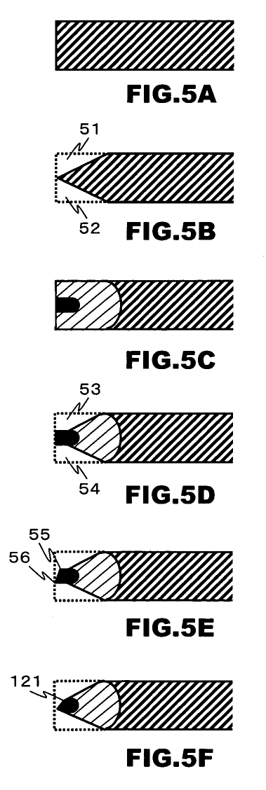

Next, a method for manufacturing such a pencil is described with reference to FIGS. 5A through 5F. FIG. 5A shows a pencil without the tip portion 121. In this state, before the tip portion 121 is formed, the parts above and below the tip of the pencil (51 and 52 in FIG. 5 B) are cut off. Thus, a pencil as shown in FIG. 5B is obtained. It is preferable that the portions 51 and 52 in FIG. 5B are substantially equivalent. Cutting substantially in an equivalent fashion on both sides makes it easy for the user to mark the marking spots while observing them and also makes it easier for the user to fill out the marking spots.

FIG. 5C is a top view in which FIG. 5B is taken directly from above. With the pencil in FIGS. 5B and 5C it is not yet possible to fill out a marking spot on the answer sheet, since the portions that are connected to the grasping portion 11 on the sides of the tip of the pencil lead 12 of the pencil are in the way.

Next, those portions (53 and 54) that are connected to the grasping portion 11 on the sides of the tip of the pencil lead 12 of the pencil are cut off. As a result, the pencil shown in FIG. 5D is obtained. With the pencil shown in FIG. 5D, a user can fill out the marking spots of an answer sheet.

Next, since the user ordinarily holds the pencil obliquely, the tip portion 121 of the pencil lead 12 is cut off obliquely, in a straight line. In other words, the tip portion 121 of the pencil lead 12 is provided with an obliquely cut-off portion. Thus, a pencil as shown in FIG. 5E is obtained. In this manner, the filling in becomes easier for most users, while the width of the pencil lead when performing a stroke is enlarged and it becomes easier to fill out the marking spots with one stroke.

Next, the boundary between the pencil lead 12 and the grasping portion 11 of FIG. 5E forms a predetermined angle, and the sharp angles (55, 56) of the pencil lead are susceptible to fractures and cracks. Accordingly, the sharp angles of the pencil lead (55, 56) are shaved off to provide continuity from the grasping portion 11 to the tip portion 121 of the pencil lead 12, thus attaining the shape shown in FIG. 5F.

A pencil according to an embodiment of the present invention fills out spaces of at least a predetermined width, so the writing pressure is overall reduced. Therefore it is preferable that it is a pencil with a dark pencil lead, such as 2B or 3B.

As explained above, with a pencil according to an embodiment of the present invention, it is possible to fill out the marking spots of an answer sheet comfortably and quickly. Moreover, with a pencil according to an embodiment of the present invention, it is possible to fill out marking spots without wasting the pencil lead.

As explained above, a pencil according to the present invention brings about the effect that it is possible to fill out the marking spots of an answer sheet comfortably, quickly, and without wasting the pencil lead, so that it is advantageous as a pencil for marking answer sheets.

1. A pencil wherein the shape of a surface of a tip portion of a pencil lead is a substantially rectangular shape.

2. The pencil according to claim 1,
wherein the length of the longer sides of the substantially rectangular shape is at least about 2 mm and at most about 5 mm.

3. The pencil according to claim 1,
wherein the length of the shorter sides of the substantially rectangular shape is at least about 0.3 mm and at most about 0.8 mm.

4. The pencil according to claim 1,
wherein the length of the longer sides of the substantially rectangular shape is approximately the diameter of the pencil lead.

5. The pencil according to claim 1,
wherein the surface area of the tip portion of the pencil lead is smaller than the cross-sectional area of the pencil lead.

6. The pencil according to any of the claims 1 to 5,
wherein the tip portion of the pencil lead comprises an obliquely cut-off portion.

7. The pencil according to claim 6,
wherein the obliquely cut-off portion defines an angle of 3 to 30° with respect to a plane intersecting orthogonally with the longitudinal direction of the pencil lead.

8. The pencil according to any of the claims 1 to 5,
wherein the pencil lead has a hardness of 2B or 3B.
